(19) United States
(12) Patent Application Publication
(10) Pub. No.: US 2002/0074283 A1
(43) Pub. Date: Jun. 20, 2002

(54) Water-insoluble linear polysaccharides for filtration

(76) Inventors: Holger Bengs, Frankfurt (DE); Gitte Bohm, Frankfurt (DE); Jurgen Grande, Bad Soden (DE); Silke Schuth, Ruppach-Goldhausen (DE)

Correspondence Address: Peter D. McDermott, Banner & Witcoff, Ltd., 28th Fl., 28 State Street, Boston, MA, 02109-1775, US

(21) Appl. No.: 09/915,917

(22) Filed: Jul. 26, 2001

Related U.S. Application Data
(63) Continuation of application No. PCT/EP99/09288, filed on Nov. 30, 1999.

(30) Foreign Application Priority Data
Jan. 26, 1999 (DE) 199 02 917.2

(51) Int. Cl. B01D 65/00

(52) U.S. Cl. 210/500.21; 210/500.27; 264/41

(57) ABSTRACT

The invention relates to the use of water-insoluble, linear polysaccharides as a filtering agent, to a method for producing said filtering agent and to a filtering device. The inventive filtering agent have a high capacity for absorption and retention.

The present invention relates to the use of water-insoluble linear polysaccharides as filter media.

Filter processes for separating solid particles or dissolved substances from liquids or gases play an important role in many industrial sectors, for example waste water purification. Particular importance is assigned to the separation of dissolved, colloidal or suspended particles from liquids, in particular in the sectors of analytical chemistry, biotechnology and of molecular biology, for example for harvesting microorganisms or for isolating nucleic acids and proteins.

The filter media used are generally porous media, through which flows the liquid or gaseous phase comprising the substances to be removed. Depending on the type of the filter medium, gas molecules, liquid molecules or solvent molecules pass through the pores of the filter medium, while dispersed or dissolved particles are retained on the surface of the porous medium or in its interior.

Filter media as used in customary separation processes are, for example, paper, cloth or non wovens made of metal fibers, natural fibers, artificial fibers and glass fibers, membranes, for example made of cellulose acetate, or sintered glass or porcelain.

For applications in analytical chemistry or molecular biology, particularly fine-pored or microporous filter media are frequently required, for example for microfiltrations. In the filter apparatuses known for such purposes, primarily prefabricated filter media are used, which consist, for example, of synthetic or semisynthetic polymers. Frequently, the materials are fabric made of synthetic or natural fibers which, in addition, can be stuck together with a binder. Generally, slices are cut from the fabric and positioned, for example, in a sample tube.

The use of chemically modified polysaccharides, for example cellulose derivatives such as nitrocellulose or cellulose acetate, or chemically crosslinked amylose, as filter media is also known.

EP-A-826 412 and WO 98/08594 describe processes for producing filter elements in which substances such as microparticles, for example in suspensions or in hydrocolloids, are solidified in spongy form to give microporous elements. Suitable microparticles consist, inter alia, of silicon dioxide, aluminum oxide, glass, graphite, calcium phosphate or zinc polyphosphate or of organic materials such as highly crosslinked polysaccharides, as are available, for example, under the trade name SUPERDEX®.

JP-A-57, 063,302 describes microparticles made of amylose having a degree of swelling of >5 for use in gel filtration. To produce the microparticles the amylose is first isolated from starch. Aqueous alkaline solutions of the amylose are then suspended in media in which the amylose does not dissolve, or dissolves only poorly, to form the microparticles, and then the particles are made water-insoluble by chemical crosslinking, for example using epichlorohydrin. In a similar manner RO-A-61,524 also describes the use of epichlorohydrin-crosslinked amylose for gel filtration.

U.S. Pat. No. 3,350,221 describes the use of starch having a high amylose content together with a melamine/formaldehyde resin forming filter sheets. In this case the melamine resin obviously crosslinks with the starch hydroxyl groups and as a result gives a water-stable filter sheet. JP-A-06,329 561 describes means for separating optically active compounds. In this case polysaccharides such as cellulose or dextran are chemically bound to a silica gel. The separation of optical isomers using amylose-coated silica gel is described in JP-A-0,346 950.

GB-A-2 247 242 describes microparticles of amylose which are obtained from cyclodextrin or starch by the action of a cyclyomaltodextrin-glucanotransferase. These water-soluble microparticles can be used in foods, pharmaceuticals and cosmetics.

However, for use as filter media, the polysaccharides used in the prior art must be chemically modified or crosslinked in order to comply with the requirements as a separation material. This can lead to residual chemicals and as a result to unwanted side effects. Chemical modification or crosslinking also leads to swelling of the particles, which is frequently unwanted.

In the multiplicity of possible applications, in particular in the sectors of analytical chemistry and biotechnology, there is therefore a great need for novel filter materials which make available alternative possibilities for separating and purifying substances, so that optimum and gentle separation and purification of the material can always be ensured under as many conditions as possible.

The object of the present invention is therefore to provide filter media for which, if appropriate even without chemical modification of the starting material, are suitable for the efficient separation of mixtures of substances, which are stable, and which may be used in a versatile manner and advantageously, for example in analytical preparative chemistry, biochemistry and molecular biology, and in particular for microfiltrations.

This object was achieved using water-insoluble linear polysaccharides as filter media. The present invention therefore relates to filter media which comprise at least one water-insoluble linear polysaccharide.

The invention further relates to a process for producing filter media comprising the steps:

(a) dissolving or suspending at least one water-insoluble linear polysaccharide in a suitable solvent or suspension medium; and

(b) solidifying the solution or suspension with formation of the filter medium.

The present invention further relates to filter apparatuses that contain a filter medium which comprises at least one water-insoluble linear polysaccharide.

Filter media are taken to mean porous media through which a liquid or a gas can flow, with particles which are dispersed, emulsified, suspended or dissolved in the liquid or the gas being able to be retained on the surface of the porous medium or in its interior on account of, for example, sieving, affinity and/or adsorption effects.

Filter apparatuses (or filters) are taken to mean apparatuses having at least one filter medium which can be used to remove substances from liquids or gases.

Polysaccharides are taken to mean macromolecular carbohydrates whose molecules consist of monosaccharide molecules linked together by glycoside bonds. Water-insoluble polysaccharides are taken to mean polysaccharides which, according to the definition of the German Pharmacopae (DAB, Wissenschaftliche Verlagsgesellschaft mbH, Stuttgart, Govi-Verlag GmbH, Frankfurt, 9th edition 1987), in accordance with classes 4-7 come under the categories ‘sparingly soluble’, ‘slightly soluble’, ‘very slightly soluble’ and ‘practically insoluble’.

The water insolubility of the polysaccharides used according to the invention is expediently such that at least 98%, in particular at least 99.5%, of the polysaccharides used are water-insoluble under standard conditions (T=25° C.±20%; p=101325 Pascal±20%) (in accordance with at least classes 4 and 5 as specified by DAB).

Advantageously, the water insolubility of the polysaccharides used corresponds to classes 6 or 7 as specified by DAB.

Linear polysaccharides are taken to mean polysaccharides whose degree of branching is a maximum of 8%, that is to say their main chain has a maximum of 8 side chains per 100 monosaccharide units.

The degree of branching of the water-insoluble linear polysaccharides is preferably a maximum of 4%, in particular a maximum of 1.5%. In the case of the inventively preferably used α-1,4-D-glucans and β-1,3-D-glucans, the degree of branching in the 6 position is a maximum of 4%, preferably a maximum of 2% and in particular a maximum of 0.5%, and the degree of branching in the other positions not participating in the linking of the main chain, for example the 2- or 3-position in the case of the particularly preferred α-1,4-D-glucan, is preferably in each case a maximum of 2% and in particular a maximum of 1%.

The prefixes ‘α’, ‘β’ and ‘D’ relate here to the main chain linkages of the inventively used polysaccharides.

Suitable polysaccharides for preparing filter media are not only water-insoluble linear homopolysaccharides, but also heteropolysaccharides.

Suitable water-insoluble linear polysaccharides are, for example, water-insoluble linear mannans, pectins, gaiactans, xylans, fructans, pullulans, celluloses and amyloses. Water-insolubility can also be achieved here by novel reaction paths. In particular, biotechnology and genetic engineering processes are suitable, as generally understood, for generating insoluble structures. This is performed, for example, by producing particular qualities, for example particular purity and/or by producing particular crystalline structures which cannot be obtained by known processes.

Preferred water-insoluble linear polysaccharides are water-insoluble linear α-D-glucans and β-D-glucans. Particular preference is given to water-insoluble linear α-1,4-D-glucans, for example amylose, and β-1,3-glucans, with α-1,4-D-glucans being very particularly preferred.

The inventively used polysaccharides are essentially not swellable, or at any rate have a low swelling capacity. Expediently, the degree of swelling of the polysaccharides used is less than 1.0, preferably less than 0.8, and particularly preferably less than 0.3 with the degree of swelling of the polysaccharide being defined as the volume (in ml) which 1 g of dry polysaccharide occupies after swelling for 4 hours in water.

Particular preference is given to water-insoluble linear polysaccharides, for example, α-D-glucans such as α-1,4-D-glucans which have no branches, or their degree of branching is so low that it is no longer detectable using conventional methods.

Preferably, chemically and/or physically unmodified water-insoluble linear polysaccharides are used. Chemical and/or physical modifications are taken to mean in this case, in particular, derivatizations of the polysaccharides by introducing specific groups, covalent links to a support material, and subsequent crosslinking.

However, for certain applications, water-insoluble linear polysaccharides can also be used, whose properties, for example adsorption properties, have been chemically modified in a manner known per se, for example by esterification and/or etherification in one or more positions which do not participate in formation of the main chain. In the case of the preferred α-1,4-D-glucans, such a modification can be performed, for example, in the 2, 3 and/or 6 position.

The size of the inventively used water-insoluble linear polysaccharides can vary in a broad range. Expediently, the weight-average molecular weight M_{W} (determined by gel-permeation chromatography compared with calibration using a pullulan standard) of the polysaccharides is between 10³ g/mol and 10⁷ g/mol. Preferably, the molecular weight M_{W} is in a range from 10⁴ g/mol to 10⁵ g/mol and, particularly preferably, from 2×10⁴ g/mol to 5×10⁴ g/mol. A further advantageous range is between 2×10³ g/mol and 8×10³ g/mol.

The polydispersity M_{w}/Mₙ of the water-insoluble linear polysaccharides used can vary within broad ranges. Preferred ranges for the polydispersity are in the range from 1.01 to 50, in particular from 1.5 to 15. The use of polysaccharides having a lower polydispersity is preferred because of the improved reproducibility of the product properties.

The water-insoluble linear polysaccharides can be used alone or in a mixture with other polysaccharides suitable for producing filter media. Preferably, polysaccharides of a single type are used, in particular α-1,4-D-glucans.

The inventively used water-insoluble linear polysaccharides can be of any origin.

For example, the water-insoluble linear polysaccharides can be obtained by conventional isolation and purification from natural plant and animal sources which contain such polysaccharides.

Since most natural sources, however, do not contain the desired water-insoluble linear polysaccharides in the desired amounts, or in the necessary purity, these polysaccharides are advantageously produced by biotechnology. For example, the natural producers of water-insoluble linear polysaccharides can be genetically manipulated in such a manner that, compared with the non-manipulated organism, they contain a higher proportion of unbranched, or only slightly branched, polysaccharides, or contain a higher degree of purity.

The desired water-insoluble linear polysaccharides can also be obtained from highly branched polysaccharides by chemical or enzymatic debranching, for example using debranching enzymes such as pullulanases, isoamylases and glucanohydrolases.

Preferably, the inventively used polysaccharides are prepared by biotransformation or biocatalysis.

Biotransformation or biocatalytic preparation is taken to mean here that the water-insoluble linear polysaccharides, such as α-1,4-D-glucans, are prepared under suitable conditions in vitro by catalytic polymerization of glucose molecules, also in the form of sucrose and/or glucose derivatives, in the presence of a suitable enzyme, in particular an enzyme having amylosucrase activity.

An advantageous process for producing water-insoluble linear α-1,4-D-glucans is described in WO 95/31553, the disclosure of which is expressly incorporated herein by reference. According to the process of WO 95/31553, the α-1,4-D-glucan is prepared by means of a biocatalytic process from sucrose in the presence of an enzyme having amylosucrase activity, in particular an amylosucrase from bacteria from the species Neisseria polysaccharea. These enzymes catalyze the formation of α-1,4-glycosidically linked glucans by transferring the glucosyl radical of the sucrose molecule to the growing polymer chain in accordance with the following reaction equation

sucrose+(α-1,4-D-glucosyl)ₙ→D-fructose+(α-1,4-D-glucosyl)ₙ₊₁

with the release of D-fructose.

A particularly preferred process for producing water-insoluble linear α-1,4-D-glucans on the basis of the above reaction equation is described in the earlier German patent application 19827978.1-42, which was not published prior to the present application, and the disclosure of which is expressly incorporated herein by reference. In this process the water-insoluble linear α-1,4-D-glucans are synthesized from sucrose using enzymes having amylosucrase activity, preferably from Neisseria polysaccharea, in aqueous, buffer-free systems. The reaction can also be carried out in the presence of a water-soluble linear or branched α-1,4-D-glucan, for example a water-soluble dextrin, or a water-soluble amylose, since such glucans act as glucosyl group acceptors, at which the enzyme catalyzes a 1,4-glucan chain extension.

In such a chain extension, branched polysaccharides also produce water-insoluble linear polysaccharides within the meaning of the present invention, since the degree of branching of the glucosyl group acceptor decreases sharply with increasing chain extension, that is increasing degree of polymerization. For this purpose, the sucrose is used in a great molar excess to the acceptor. In this manner, α-1,4-D-glucans having a molecular weight in the range from 0.75×10² g/mol to 10⁷ g/mol may be prepared. The linear oligomeric or polymeric acceptors can either be added from the outside, or they can also be generated from sucrose by the amylosucrase itself.

In a particular embodiment, the water-insoluble linear polysaccharides are used in the form of microparticles, the microparticles being able to consist in whole or in part of these polysaccharides.

The form of the microparticles is not very critical, expediently, however, the microparticles are used in spherical shape. Spherical microparticles are taken to mean in this case approximately sphere-shaped microparticles whose deviation in axial lengths is no more than 40% from the ideal state of a sphere which is described by axes directed into three dimensional space that start from a common origin, are of the same length and define the radius of the sphere in all spatial directions. Preferably, spherical microparticles are used which have deviations of no more than 25%, particularly preferably no more than 15%.

The mean diameter (number average) of the microparticles is expediently in a range from 1 nm to 100 μm, preferably from 100 nm to 10 μm, and particularly preferably from 1 μm to 5 μm.

The specific surface area of the microparticles is expediently in a range from 1 m²/g to 100 m²/g, preferably from 1.5 m²/g to 20 m²/g and particularly preferably from 3 m²/g to 10 m²/g.

The dispersity D=d_{w}/dₙ of the microparticles, where d_{w} is the weight average of the diameter and dₙ is the number average of the diameter of the microparticles, is expediently in a range from 1 to 10, preferably from 1.5 to 5, and with preference from 2 to 3. The means d_{w} and dₙ are defined as

dₙ=Σnᵢ×dᵢ/Σnᵢ;

and

d_{w}=Σnᵢ×dᵢ²/Σnᵢ×dᵢ

where

dᵢ is the diameter of particles of species i;

nᵢ is the number of particles i having the diameter dᵢ; and

i is a serial number.

The term weight in this context does not mean mass, but a weighted mean, whereby the larger diameters have a higher importance. The exponent 2 gives diameters of larger particles greater weight.

Advantageous processes for producing the inventively used microparticles are described in the earlier German patent applications 19737481.6, 19839214.1-44, 19839216.8-44 and 19839212.5-43, which are here expressly incorporated by reference and whose disclosure is also a part of the present description.

Expediently, the preferably spherical microparticles are obtainable by dissolving the water-insoluble linear polysaccharides in a suitable solvent, such as dimethyl sulfoxide (DMSO), formamide, acetamide, or N,N-dimethylformamide, introducing the solvent into a precipitant, preferably water, cooling the resultant mixture to, preferably, 10° C. to −10° C., and separating off the microparticles formed.

Structure and surface area of the microparticles can be controlled by the type of precipitant, for example by replacement in whole or in part of water by dichloromethane. The conjoint use of suitable additives, for example anionic, cationic or nonionic surface-active substances, such as sodium dodecylsulfate, N-methylgluconamide, polysorbates, as obtainable under the trade name Tween®, fatty acid glycol esters, alkyl polyglycol ethers, alkyl polyglycol ethersulfates, ethylene oxide-propylene oxide block polymers such as Pluronic®, alkylsulfates and sugars such as fructose, sucrose and glucose can also affect structure, size and surface area of the particles.

The concentration of the polysaccharide in the solution can vary within a wide range and is preferably between 0.1 g of polysaccharide per ml of solvent.

Microparticles having a particularly smooth surface may be obtained if water-soluble cellulose derivatives, for example cellulose esters or cellulose ethers such as hydroxypropyl methyl cellulose, hydroxyethyl cellulose, carboxymethyl cellulose, cellulose acetate, cellulose butyrate or cellulose nitrate are added to the precipitant.

Microparticles having a mean size from 0.1 μm to 3 μm may advantageously be obtained in this process if a hot-water-soluble α-D-glucan is added to the precipitant.

The porosity of the microparticles may also be controlled by selection of the water-insoluble linear polysaccharide or of the process for its preparation. Thus, for example, the addition of aids in the biotechnological preparation of the polysaccharides can affect the porosity of the microparticles obtained from such polysaccharides. In particular, it has been found that the porosity of microparticles which consist in whole or in part of water-insoluble linear α-1,4-D-glucans can be increased if the glucan is prepared from sucrose in the presence of amylosucrase and in the presence of a glucosyl group acceptor, for example dextrin or glycogen. In this case, the microparticles are more porous, the higher is the concentration of glucosyl group acceptor in the biotransformation.

The microparticles can be chemically crosslinked or noncrosslinked. In order to avoid the effect of interfering foreign chemicals which can be entrained during the crosslinking, noncrosslinked microparticles are preferred.

The inventive filter media can consist in whole or in part of water-insoluble linear polysaccharides. In an advantageous simple embodiment, the filter medium consists completely of water-insoluble linear polysaccharides and, if appropriate, other aids and additives.

The inventive filter media can be prepared from the water-insoluble linear polysaccharides in a manner known per se by forming loose or consolidated layers of differing thickness which consist in whole or in part of water-insoluble linear polysaccharides.

Consolidated layers may be produced, for example, by pressing the polysaccharides.

Processes for producing consolidated filter media and filter apparatuses are also described in EP-A-826 412 and WO 98/08594, the disclosure of which is expressly incorporated here by reference.

In a simple and expedient embodiment, the inventive filter media are prepared by first dissolving or suspending the water-insoluble linear polysaccharides in a suitable solvent or suspension medium, and then solidifying them in a porous shape suitable for the filter medium or the filter apparatus.

Suitable solvents are those as are also used in the production of the microparticles, that is to say DMSO, formamide, acetamide or N,N-dimethylformamide. The solidification from such a solution can be performed, for example, by removing the solvent, for example by evaporating the solvent by heating, or in vacuo, or the polysaccharides are precipitated by adding a precipitant which may preferably then also be readily removed, for example water.

Preferably, the inventively used polysaccharides, are in suspension, if appropriate in the form of microparticles.

Suitable suspension media are, for example, water and alcohols. Solidification can, again, be performed by evaporating the suspension medium, for example by heating, or in vacuo.

Suitable solvents and suspension media can also be hydrocolloids and polymer solutions, including resin solutions, which are solidified together with the inventive polysaccharides and incorporate these into a matrix. Suitable polymers are, for example, vinyl esters, polyamides and poly(meth)acrylates. In the solidification, care must be taken, in particular, to ensure that a porous sheet is formed and that the water-insoluble linear polysaccharides, or the microparticles therefrom, which bear filter properties, are accessible for the substances to be removed. Such processes are described extensively in EP-A-826 412 and WO 98/08594.

In addition to the water-insoluble linear polysaccharides, the inventive filter media can also contain other materials which change the properties of the filter medium, for example microparticles of silicon dioxide, aluminum oxide, glass, graphite, calcium phosphate or zinc polyphosphate, or other aids and additives. Preferably, those substances are used which do not enter into chemical reaction or covalent bonding with the polysaccharides.

The inventive filter media can be used in filter apparatuses of the most varied type for removing substances from liquids or gases.

In a preferred embodiment, the filter medium is used in the filter apparatuses together with at least one further porous element which can be below and/or above the inventive filter medium, in the direction of flow of the liquid to be treated or of the gas to be treated, and in this manner can serve as reinforcing layer, support layer, fixing layer or covering layer for the inventive filter medium or can also act as additional filter medium. In a particularly preferred embodiment, the inventive filter medium is fixed in the filter apparatus between two such elements.

The filter medium is expediently in direct contact with at least one porous element and can be covalently or noncovalently bound to this.

The porous, preferably microporous, elements can be, for example, in the form of disks, plates, meshes or nets, for example frits. They can be formed from the most varied materials and consist, for example, of particles which are firmly bound to one another. Suitable materials of which such porous elements can consist, are, for example, polyethylene, polypropylene, polyvinylacetate, polyester, polyamides, polystyrene and polycarbonate, glass, ceramic and quartz, or mixtures of different materials. Also, the elements may consist of fabrics of natural or synthetic and semisynthetic fibers or of metal grids. Particularly preferred are microporous elements such as glass filters and microporous membranes, as can be produced for microfiltration, for example, from cellulose acetate, or other cellulose derivatives, polyamides, polyvinylchloride, polysulfones and Teflon. Such elements are also described in EP-A-826 412 and WO 98/08594. A simple sheet of glass wool can also be used together with the filter medium.

If the inventive filter media are used together with a further porous element as support sheet or fixing sheet, the solidification of the filter medium can be performed directly on this element.

To produce the filter apparatuses, the filter medium can be introduced after its production into a suitable container and fixed there, or the filter medium can be formed directly in the container at the desired position. The container is designed such that it permits the flow or the passage of liquids or gases which contain the substances to be removed. Filter apparatuses which contain the inventive filter medium can, for example, be round filters which can be mounted on a syringe, by means of which the liquid which comprises the material to be removed is forced through the filter. In such an apparatus, the filter medium is expediently applied to a porous membrane, for example made of cellulose acetate, and/or is fixed between two porous membranes.

In a further advantageous embodiment, the inventive filter medium is situated in a suitable hollow body, in particular in a cylindrical hollow body. Such a hollow body can be, for example, a syringe body. Advantageously, the filter apparatus can be combined with a sample tube or centrifuge tube, so that the filtrate can be collected directly in a suitable container.

In a particularly simple and therefore advantageous embodiment for producing inventive filter apparatuses, the water-insoluble linear polysaccharides or microparticles therefrom are suspended in water, expediently in an amount such that a spreadable mixture is formed. This mixture is applied to a porous element, preferably a microporous membrane, and distributed uniformly. After drying and consolidation, desired filters can be stamped out and introduced, for example, into a centrifuge tube and fixed there in a suitable manner, for example, by sticking or melting.

In a further embodiment, the filter medium can be produced on a porous element which is already preformed in a filter apparatus, for example on a microporous membrane situated in a centrifuge tube. Such centrifuge tubes are marketed, for example, by Schleicher & Schuell under the name Centrex®.

Loose solid layers are expediently produced by deposition of the dry, pulverulent or particulate polysaccharide, for example by applying it to a porous support element, or by enclosing the material between two porous fixing elements.

Dissolved, colloidal or suspended substances can be removed from liquids or gases by sieving, affinity and/or adsorption effects of the inventive filter medium or of the water-insoluble linear polysaccharides used therein.

The inventive filter apparatuses and filter media are suitable, on account of these properties, not only for purifying liquids or gases from unwanted substances, but also for removing, purifying and isolating the substances present in the liquids or gases.

Expediently, the substances are removed from liquids or gases by allowing the liquids or gases to flow through the filter medium under conditions under which the substances to be removed are retained by the filter medium.

The flow of liquids through the filter medium is expediently facilitated by applying, for example, overpressure or underpressure to the filter apparatus. The passage through the filter medium, however, can also be facilitated by a centrifugation step.

If wanted, the substances which are removed and retained by the filter medium can be recovered, either mechanically, if the substances removed are situated on the outer surface of the filter medium, or by an elution step under conditions under which the substances removed are detached from the filter medium.

Thus, the inventive filter media can be used, for example, for removing and purifying biological material, for example nucleic acids, by passing a sample comprising the biological material through the filter medium under conditions under which the biological material is retained by the filter medium, for example in a suitable buffer, and then eluting this material from the filter medium, if appropriate after further wash steps.

A particular advantage of the inventive filter media is that they are suitable for removing and if appropriate purifying a multiplicity of substances. These include active compounds of all types, such as dyes, flavorings and aroma substances, toxic substances, for example in cigarette smoke, natural and synthetic polymers and biological material, for example nucleic acids such as single-stranded and double-stranded linear DNA, plasmid DNA and RNA, proteins such as enzymes and antibodies, or complexes of nucleic acids and proteins, for example with nucleic acid- or protein-binding substances.

The inventive filter apparatuses and filter media are suitable not only for preparative and analytical microfiltrations on a laboratory scale, in which case small amounts of valuable substances can be produced from small sample volumes substantially without losses and without contamination, but also for solid-liquid separations on a larger scale, for example for clarifying liquids, harvesting cells and for removing cell debris. The filter media may, in addition, be simply and rapidly handled, are resistant to a multiplicity of solvents, and, because of their biodegradability, can also be disposed of in an environmentally friendly manner.

The inventively used water-insoluble linear polysaccharides have high adsorption capacity and retention capacity, which is essentially independent of the size and chemical and biological structure of the substance to be filtered off. The filter media can be simply and rapidly produced. In particular, they can be produced by users themselves, in accordance with the respective requirements, and in small amounts, so that there is no need to have recourse to prefabricated filters. The properties of the filter media may also be varied within a broad range and geared to individual requirements, for example by changing the porosity of the filter media, for example by varying the polysaccharide microparticles used, or by adding other substances. This is of great importance especially in scientific research.

The present invention will be described in more detail below with reference to drawings and examples.

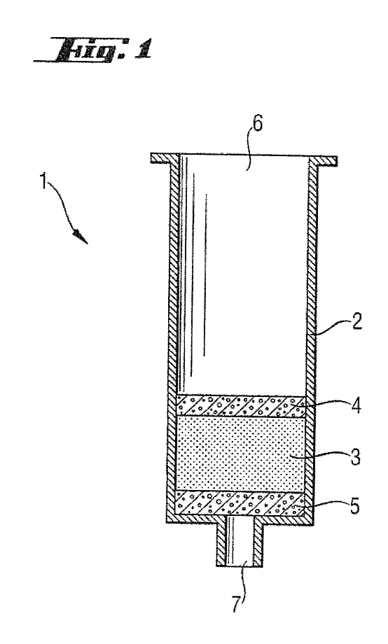

FIG. 1 shows a particular embodiment of an inventive filter apparatus, that is to say a filter apparatus 1 which has a container 2 in the form of a cylindrical hollow body which contains the filter medium 3, for example in the form of microparticles. The filter medium is fixed between two porous elements 4 and 5. The apparatus, in addition, has an inlet opening 6 for charging liquid, and an outlet 7 for the filtrate.

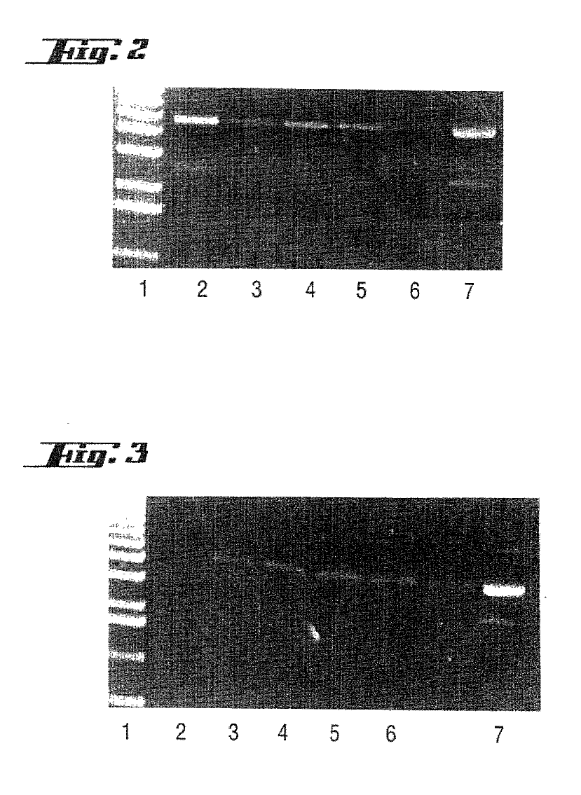

FIG. 2 shows the analysis (detection with ethidium bromide 0.5 pg/ml at 256 nm in accordance with example 9, see legend) of a plasmid-DNA-containing liquid after passage through an inventive filter on an agarose gel; that is to say from left to right:

| | |
|---|---|
| Track 1: | Marker (Boehringer Mannheim DNA Molecular Weight Marker X) |
| Track 2: | Filter 2 without filter medium (blank reference) |
| Track 3: | Filter 2 filled with inventive filter medium |
| Track 4: | Filter 1: Qiagen ® cartridge containing inventive filter medium |
| Track 5: | Filter 1: Qiagen ® Midipräp (Hilden, Germany) reference |
| Track 6: | Filter 2 containing filter medium |
| Track 7: | Pure DNA plasmid solution (commercially available plasmid pBluescript II SK) |

FIG. 3 shows the analysis (detection using ethidium bromide 0.5 pg/ml at 256 nm according to example 9, see legend) of the eluates of the bound plasmid DNA from the inventive filters using a suitable buffer on an agarose gel; that is to say from left to right:

| | |
|---|---|
| Track 1: | Marker (Boehringer Mannheim DNA Molecular Weight Marker X) |
| Track 2: | Filter 2 without filter medium (blank reference) |
| Track 3: | Filter 2 filled with inventive filter medium |
| Track 4: | Filter 1: Qiagen ® cartridge containing inventive filter medium |
| Track 5: | Filter 1: Qiagen ® Midipräp (Hilden, Germany) reference |
| Track 6: | Filter 2 containing filter medium |
| Track 7: | Pure DNA plasmid solution (commercially available plasmid pBluescript II SK) |

### EXAMPLES

### Example 1

Preparation of Water-insoluble Linear α-1,4-D-glucans

a) 15 l of a 20% strength sucrose solution were added to a sterile 25 l vessel. To this were added 120 ml of amylosucrase-containing enzyme extract from a production strain transformed with the amylosucrase gene from Neisseria polysaccharea. The enzyme activity was 20 units (1 unit=1 μmol of sucrose×min⁻¹×mg of enzyme). The biotransformation was carried out in the absence of glucosyl group acceptors.

The apparatus was fitted with a sterile KPG stirrer and sealed and stirring was carried out at 39° C. A white precipitate had formed even after a few hours. The reaction was terminated after 59 hours. The precipitate was filtered off and washed twice with water to remove low-molecular-weight sugars. The residue remaining in the filter was dried at 38° C. in a drying cabinet under reduced pressure. The mass of α-1,4-D-glucan obtained was 893 g, corresponding to a yield of 59%. The molecular weight (measured using gel-permeation chromatography (GPC), solvent DMSO; calibration with pullulan standards) was M_{W}=9000 g/mol; Mₙ=4400 g/mol; M_{W}/Mₙ=2.05 (glucan 1a).

b) The biotransformation was carried out as described under example 1a, but 0.1% dextrin (w/v) was added as glucosyl group acceptor (glucan 1b).

### Example 2

Production of microparticles from α-1,4-D-glucans

a) 200 g of the α-1,4-D-glucan (glucan 1a) obtained in accordance with example 1a) were dissolved in 1 l of dimethyl sulfoxide (DMSO; Riedel-de-Haen) at 50° C. The solution was then slowly added dropwise to 8 l of twice-distilled water. The batch was kept overnight at 4° C. A fine suspension of microparticles formed, which was separated off by decanting. The bottom sediment was slurried and centrifuged for 5 min at 5000 rpm in an ultracentrifuge (type RC5C). The solid residue was slurried three times with twice-distilled water and centrifuged again. The solids were collected and the still-moist suspension was freeze-dried (Christ Delta 1-24 KD). 176 g of white solids were isolated (yield 88%). The resultant microparticles are of spherical shape and the particle diameters are in the majority between 2 and 3 μm, as determined by scanning electronmicroscopy (SEM; Camscan S-4).

The specific surface area was determined using a sorptomatic 1990 (Fisons Instruments) using the ‘default method sorptomatic’ setting. For the study, the samples were dried overnight at 80° C. in vacuo, the resultant α-1,4-D-glucan having been ground in advance using a commercially conventional mill (Waring®), so that the mean particle size was less than 200 μm. The specific surface area was 4.5 m²/g (microparticles 2a).

b) The microparticles were produced as in example a), but the α-1,4-D-glucan (glucan 1b) obtained as in example 1b) was used. The specific surface area was 2.9 m²/g (microparticles 2b).

### Example 3

Filtration of a Dye Using an α-1,4-D-glucan

200 mg of the microparticles obtained according to examples 2a and 2b were weighed out into a centrifuge vessel having a microporous membrane (Schleicher & Schuell, Centrex MF-5.0, 0.45 μm, Germany). Then, 3 ml of a 0.04% strength brilliant blue solution in deionized water were added. The vessel was closed and the particles were then shaken and slurried. The suspension was left to stand for 1 minute. It was then centrifuged at 3000 rpm (Labofuge GL, Heraeus). A visual assessment showed that coloring was reduced to no longer present. The microparticles were markedly stained blue.

The liquid which was flushed through, the filtrate, was charged into a quartz cuvette and measured on a UV-vis spectrometer (Beckmann, UV-DU 640, Germany). Measurements were made at the adsorption maximum of brilliant blue (λₘₐₓ=552 nm). The results are shown in table 1.

TABLE 1

| Glucan | Micro-particles | Surface area (m²/g) | SEM | Extinction |
|---|---|---|---|---|
| (0.04% strength | — | — | — | 2.0487 |
| starting solution) | | | | |
| Glucan 1a | 2a | 4.53 | 1-3 μm particle | 0.0251 |
| | | | diameter; | |
| | | | spherical to | |
| | | | bead-shaped | |
| Glucan 1b | 2b | 2.90 | Coherent | 0.1228 |
| | | | morphology, batchwise | |
| | | | particles, cleft, | |
| | | | cotton wool-like | |

SEM scanning electronmicroscopy
Glucan 1a: α-1,4-D-glucan from example 1a)
Glucan 1b: α-1,4-D-glucan from example 1b)
Microparticles 2a: Microparticles from example 2a)
Microparticles 2b: Microparticles from example 2b)

### Example 4

### Comparison Example

Filtration of a Dye using Different Starches

For comparison with the inventive water-insoluble α-1,4-D-glucans, the experiments of examples 2 and 3 were carried out using various commercially available natural starches from potato and corn having different ratios of amylose to amylopectin.

The results are shown in table 2.

TABLE 2

| Glucan | Micro-particles | Surface area (m²/g) | SEM | Extinction |
|---|---|---|---|---|
| (0.04% strength | — | — | — | 2.0487 |
| starting | | | | |
| solution | | | | |
| Toffena*1 | none | 1.28 | natural grain | 1.6535 |
| | | | structure | |
| | | | (approx. 20-100 | |
| | | | μm); smooth | |
| | | | surface | |
| Hylon VII*2 | none | 2.12 | natural grain | 0.2689 |
| | | | structure | |
| | | | (approx. 20-100 | |
| | | | μm); smooth | |
| | | | surface | |

| | | | |
|---|---|---|---|
| Amylose*3 | — | 1.54 | A study could not be carried out |
| | | | because of solubility in water. |

*1 Potato starch from Südstärke, Germany (approx. 17% amylose content)
*2 Corn starch from National Starch, USA (approx. 60 to 70% amylose content)
*3 Potato starch amylose from Merck AG (>90% amylose content).

The results show the superiority of the inventive water-insoluble linear polysaccharides compared with water-soluble and branched polysaccharides.

### Example 5

Production of Filters for the Filtration of Food Dyes

To produce a filter for the filtration of food dyes, a metal filter was prepared (Millipore, micro-syringe 25 mm filter holder; USA). For this, a 0.5 μm filter (Millipore, Filter Type FH, FHLC 047 00; USA) was attached to a sealing ring. The height of the sealing ring was approx. 2 mm. The microparticles (80 mg) were moistened with a little water so as just to give a spreadable mixture. The moistened microparticles were placed in the prepared filter holder. Above this was laid a fine metal sieve. This arrangement was firmly sealed with the upper part of the metal filter. The metal filter prepared in this manner was fixed on a disposable syringe (Beckton Dickinson). Then 4 ml of a 0.05% strength solution of a food dye (Annatto W. S. 14% ProAndina Rohstoffe GmbH) in deionized water were placed in the syringe and forced through the filter. The particles are visually discernibly dyed. The dye cannot be washed out from the particles using fresh deionized water. The solution is yellowish.

### Example 6

Determination of the Retention Capacity of Various α-1,4-D-glucans

To determine the retention capacity of various α-1,4-D-glucans for the dye brilliant blue, the dyed microparticles of various glucans obtained in accordance with examples 3 and 4 were placed as described in example 3 into a centrifuge tube and 3 ml of deionized water were added. The suspensions were allowed to stand for 1 minute. They were then centrifuged at 3000 rpm (Labofuge GL, Heraeus).

The resultant filtrate was clear.

The color of the washed microparticles was assessed visually and the filtrate was measured spectroscopically. The results are shown in table 3.

The mass balances of the filtrations, the retention capacity (%) and the irreversible content (%) are shown in table 4.

TABLE 3

| | | | Visual | Visual |
|---|---|---|---|---|
| | | | assessment of | assessment of |
| | Extinction 1st | Extinction 2nd | the micro- | the micro- |
| Glucan | filtrate | filtrate | particles (plan view) | particles (side view) |
| (0.04% strength | 2.0487 | — | — | — |
| starting solution | | | | |
| Glucan 1a | 0.0251 | 0.0062 | Intensely violet | Homogeneously |
| | | | | dyed filter cake |
| Glucan 1b | 0.1228 | 0.1059 | Intensely violet | approx. 80% |
| | | | | homogeneously |
| | | | | dyed filter cake |
| Toffena | 1.6535 | 0.0357 | White | Virtually white |
| | | | | filter cake |
| Hylon VII | 0.2689 | 0.3086 | Blue | Coloration of |
| | | | | the filter cake |
| | | | | not homogeneous |

TABLE 4
Mass balance of the filtrations, percentage retention capacity and
irreversible content in percent.

| | Amount | Amount | | Amount in | |
|---|---|---|---|---|---|
| | adsorbed in | flushed | Retention | wash | |
| | filter cake | through | capacity | solution | Irrever-sible |
| Glucan | (μg) | (μg) | (%) | (μg) | amount (%) |
| (0.04% | — | 120 μg | — | — | — |
| strength | | | | | |
| starting | | | | | |
| solution | | | | | |
| Glucan 1a | 118.5 μg | 1.5 μg | 98.8 | 0.4 μg | 0.34 |
| Glucan 1b | 112.8 μg | 7.2 μg | 94.0 | 6.2 μg | 5.50 |
| Toffena | 23.1 μg | 96.9 μg | 19.3 | 2.3 μg | 10.9 |
| Hylon VII | 104.3 μg | 15.7 μg | 86.9 | 18.1 μg | 17.35 |

### Example 7

Filtration of a Dye using α-1,4-D-glucan and Comparison Substances as a Function of Time

The procedure was followed as described in example 3 using brilliant blue. However, the time dependency was studied. For this, the microparticle suspensions were allowed to stand with the dye once for 1 minute and once for 2 minutes, before the solution was centrifuged. The results are shown in table 5.

TABLE 5
Time dependency of the filtration of dyes using α-1,4-D-glucans

| | Extinction | Extinction | Percentage improvement |
|---|---|---|---|
| Glucan | filtrate after 1 minute | filtrate after 2 minutes | on doubling time |
| (0.04% strength | 2.0487 | 2.0487 | 0 |
| starting solution) | | | |
| Glucan 1a | 0.0251 | 0.0102 | 59.4 |
| Glucan 1b | 0.1228 | 0.1218 | 0.81 |
| Toffena | 1.6535 | 1.6207 | 2.0 |
| Hylon VII | 0.2689 | 0.2353 | 12.5 |

### Example 8

Production of the Filter Apparatuses

To remove biological material (nucleic acids inter alia) from liquids, a number of filter apparatuses according to FIG. 1 were produced.

As a first embodiment, a filter apparatus 1 having a cylindrical hollow body 2 of polyethylene was produced, which had a diameter of 1.5 cm. The outlet 7 had a diameter of 2-3 mm. At the lower end of the hollow body 2, before the outlet 7, was situated a glass filter as porous element 5, onto which 580 mg of a water-insoluble linear α-1,4-D-glucan (according to examples 2a and 2b) were applied as filter medium 3. The filter medium 3 was covered with a further glass filter as porous element 4. Filters 1 (see FIG. 1) were obtained in this manner.

A further embodiment was designed as for filter 1, with the exception that the porous element 5 used was a cellulose filter and the porous element 4 used was a layer of glass wool. In this manner, filter 2 was obtained.

### Example 9

Separation of Nucleic Acid

Separation or retention of substances, use of the filter medium for separating off biological material, in particular nucleic acid.

Disposable centrifuge filters (Schleicher & Schüll, e.g. Centrex, catalog number 467012 (April 1996): ‘Filter 1’ in FIG. 2 and FIG. 3) are equilibrated with 3 ml of a buffer 1 (see below) solution using 580 mg of the microparticles produced according to example 2a and 2b as filter medium (if necessary centrifuge (2000 rpm)). Then, 2 ml of an aqueous DNA plasmid solution (plasmid used: pBluescript II SK) of a concentration 50 μg/ml are placed onto the filter (if appropriate centrifuge (5 min at 2000 U/min)). A reference run is performed using (‘Filter 2’ in FIG. 2 and 3) Qiagen® Midipräp (Hilden, Germany) and a further reference run is performed using Qiagen® Midipräp—cartridges without Qiagen® filter medium, which have been charged with the inventive filter medium.

In each case 5 μl of eluate is made about 1/10 of the concentration with dye reagent (marker) and applied (60% sucrose, 20 mM EDTA, 0.025% bromophenol blue) to an agarose gel plate, with subsequent gel electrophoresis (Biorad, Power Supply, Model 100/200). As a reference for estimating and classifying plasmids detected, a marker (MW 5000) is applied to track 1 and the DNA plasmid solution used is applied as reference. FIG. 2 shows that the sample DNA was retained on the inventive filter medium.

Then, 5 ml of a second buffer (buffer 2) are applied to the column (filter) for elution, and rapidly worked up by centrifugation (5 min at 2000 rpm).

The eluates (references as aforesaid) are applied (60% sucrose, 20 mM EDTA, 0.025% bromophenol blue) to an agarose gel plate and then gel electrophoresis is carried out (Biorad, Power Supply, Model 100/200) (see FIG. 3). As a comparison, a marker (MW 5000) (track 1) and the DNA plasmid solution (track 7) were applied.

Buffer Description

| | |
|---|---|
| Buffer 1: | 750 mM NaCl |
| | 50 mM MOPS |
| | (3-[N-morpholino]propanesulfonic acid, pKa 7.2) |
| | 15% isopropanol |
| | 0.15% Triton ® X-100 |
| Buffer 2: | 1.25 M NaCl |
| | 50 mM tris, tris*clm, pH 8.5 |
| | 15% isopropanol |

The results which are shown in FIG. 3 demonstrate that the plasmid DNA can be eluted without problems from the filter medium. Comparison with the commercial filter materials shows that the inventive filter medium based on water-insoluble linear α-1,4-D-glucans has at least the same quality as the already known filter media.

1. A filter medium which comprises at least one water-insoluble linear polysaccharide.

2. The filter medium as claimed in claim 1, wherein the at least one water-insoluble linear polysaccharide is selected from α-1,4-D-glucans and β-1,3-D-glucans.

3. The filter medium as claimed in claim 2, wherein the water-insoluble linear α-1,4-D-glucan is an amylose.

4. The filter medium as claimed in one of claims 2 or 3, wherein the water-insoluble linear α-1,4-D-glucan is obtainable by in-vitro polymerization of glucose in the presence of an enzyme having amylosucrase activity.

5. The filter medium as claimed in one of claims 1 to 4, wherein the water-insoluble linear polysaccharide is in the form of microparticles.

6. The filter medium as claimed in claim 5, wherein the microparticles are spherical.

7. The filter medium as claimed in claim 6, wherein the microparticles have a mean diameter from 1 μm to 5 μm.

8. The filter medium as claimed in one of claims 5 to 7, wherein the microparticles have a specific surface area from 3 m²/g to 10 m²/g.

9. The filter medium as claimed in one of claims 1 to 8, wherein the filter medium is microporous.

10. The filter medium as claimed in one of claims 5 to 9, wherein the microparticles are obtainable by dissolving the water-insoluble linear polysaccharide in a solvent, introducing the solution into a precipitant and cooling the resulting mixture.

11. The filter medium as claimed in one of claims 1 to 10, wherein the water-insoluble linear polysaccharide is incorporated into a porous matrix.

12. The filter medium as claimed in claim 11, wherein the matrix is a polymer matrix.

13. A filter apparatus containing a filter medium as claimed in one of claims 1-12.

14. The filter apparatus as claimed in claim 13, comprising at least one further porous element.

15. The filter apparatus as claimed in claim 14, wherein the porous element is a microporous membrane.

16. The filter apparatus as claimed in one of claims 13 to 15, wherein the porous element is in direct contact with the filter medium and, in particular, is covalently or noncovalently bound to this.

17. A process for producing a filter medium as claimed in one of claims 1 to 12, or a filter apparatus as claimed in one of claims 13 to 16, comprising the steps
a) dissolving or suspending at least one water-insoluble linear polysaccharide in a suitable solvent or suspension medium; and
b) solidifying the suspension with formation of a filter medium.

18. The process as claimed in claim 17, wherein the at least one water-insoluble linear polysaccharide is selected from α-1,4-D-glucans and β-1,3-D-glucans.

19. The process as claimed in claim 18, wherein the at least one water-insoluble linear α-1,4-D-glucan is an amylose.

20. The process as claimed in one of claims 17 to 19, wherein the at least one water-insoluble linear polysaccharide is in the form of microparticles, in particular spherical microparticles.

21. The process as claimed in one of claims 17 to 20, wherein the suspension medium is selected from the group consisting of water, alcohols, polymer solutions and hydrocolloids.

22. The process as claimed in one of claims 17 to 21, wherein the suspension, for solidification, is applied to a porous element.

23. The process as claimed in one of claims 17 to 22, wherein the porous element is a microporous membrane.

24. The use of water-insoluble linear polysaccharides as filter medium.

25. The use as claimed in claim 24, wherein the water-insoluble linear polysaccharide is selected from α-1,4-D-glucans and β-1,3-D-glucans.

26. The use as claimed in one of claims 24 or 25, wherein the water-insoluble linear polysaccharide is in the form of microparticles, in particular spherical microparticles.

27. The use as claimed in one of claims 24 to 26 for separating and if appropriate purifying and isolating biological material from liquids.

28. The use as claimed in claim 27, wherein the biological material is a nucleic acid.
